(19) United States
(12) Patent Application Publication
(10) Pub. No.: US 2003/0136003 A1
(43) Pub. Date: Jul. 24, 2003

(54) Mechanical device with oscillating blades which may be moved on all the orthogonal planes

(76) Inventor: Franco Casttelmani, Gerano (IT)

Correspondence Address: John S. Egbert, Harrison & Egbert, 412 Main Street, 7th Floor, Houston, TX, 77002, US

(21) Appl. No.: 10/337,472

(22) Filed: Jan. 7, 2003

(30) Foreign Application Priority Data
Jan. 23, 2002 (IT) RM2002A 000028

(51) Int. Cl. B26D 3/16

(52) U.S. Cl. 30/100

(57) ABSTRACT

Mechanical device capable of moving blades on orthogonal planes. The type of movement, which is due to the particular mechanism, is the most important aspect of the invention. The device is for use mainly in gardening and farming, for mowing and for clipping to the side and above hedges. It may be fitted to a traditional clearing machine, It may be classified in the technical sector of electromechanical devices and in the field of application of working tools.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

1. Field of the Invention

The invention concerns a mechanical device with oscillating blades which are moved in such a way that the operator can easily clear bushes and branches, cut grass and mow a lawn. The blades can be adjusted to work on all orthogonal planes so that the operator can reach any required position with respect to the areas to be cut.

As can be clearly seen, the most innovative aspect of this invention is the configuration of the mechanical device, for which a specific claim will be made below, since it may be used in mechanical devices which must be moved on orthogonal planes.

The invention may be classified in the technical sector of electromechanical devices and in the field of application of agricultural and garden tools.

### BACKGROUND OF THE INVENTION

Until now, automatic hedge trimmers and lawnmowers always included another tool. The operator removed the bevel gear pair installed on the most-commonly used machines in this sector and installed a mechanism fitted with blades which always had limitations for the performance of the work. In fact, the trimming of the upper sides of hedges was carried out with these machines with the operator in front of the hedge. This was very uncomfortable for the operator since he had to walk sideways without knowing where to place his feet, which could be dangerous and also lead to inaccurate trimming.

### BRIEF SUMMARY OF THE INVENTION

The mechanical device covered by this invention, and subject of this request for a patent, is easily installed on the existing bevel gear pair of any trimmer. As explained below, as well as mowing at ground level, it enables, with the blades set at approximately 90°, all the operations for the vertical trimming of hedges as well as cutting to the top. This is carried out whilst walking along the sides of the hedge thereby guaranteeing safety for the operator and accuracy in the cutting operations.

The description of the invention given below is for illustrative purposes only and based on a version of the device currently preferred by the inventor. Reference should be made to the attached figures (FIG. 10 is shown with the summary).

### BRIEF DESCRIPTION OF THE SEVERAL VIEWS OF THE DRAWINGS

FIG. 1—Schematic layout of mechanical device, in which a, b and indicate some of the blade positions;

FIG. 2—Schematic layout of mechanical device, showing that blades may be set in any position: a, b, c, d, etc;

FIG. 3A—Schematic diagram of a blade;

FIG. 3B—Blade unit on adjustable support;

FIG. 4—Cross-section of device;

FIG. 5—Gear box;

FIG. 6—Main body showing fixing points and adjustment device;

FIG. 7—Gear box with clutch unit;

FIG. 8—Epicycloidal gear unit with straight teeth;

FIG. 9—Lower and upper oscillating rods;

FIG. 10—Circular rack ratchet lock;

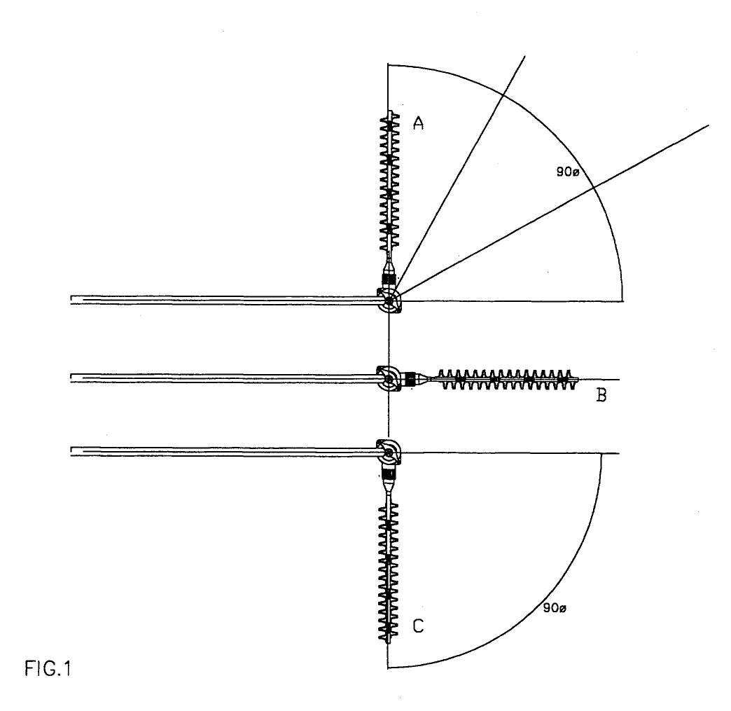

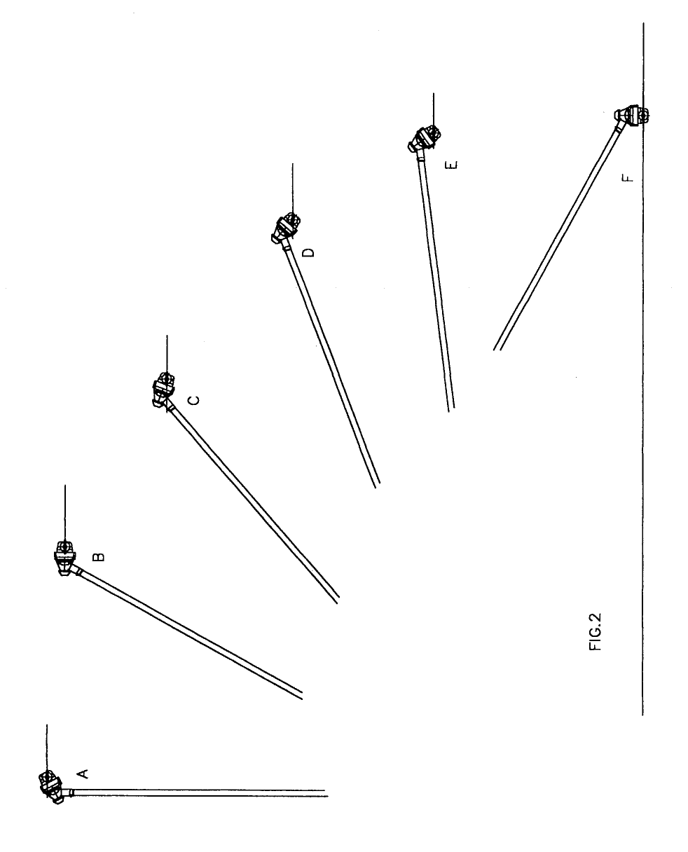

### DETAILED DESCRIPTION OF THE INVENTION

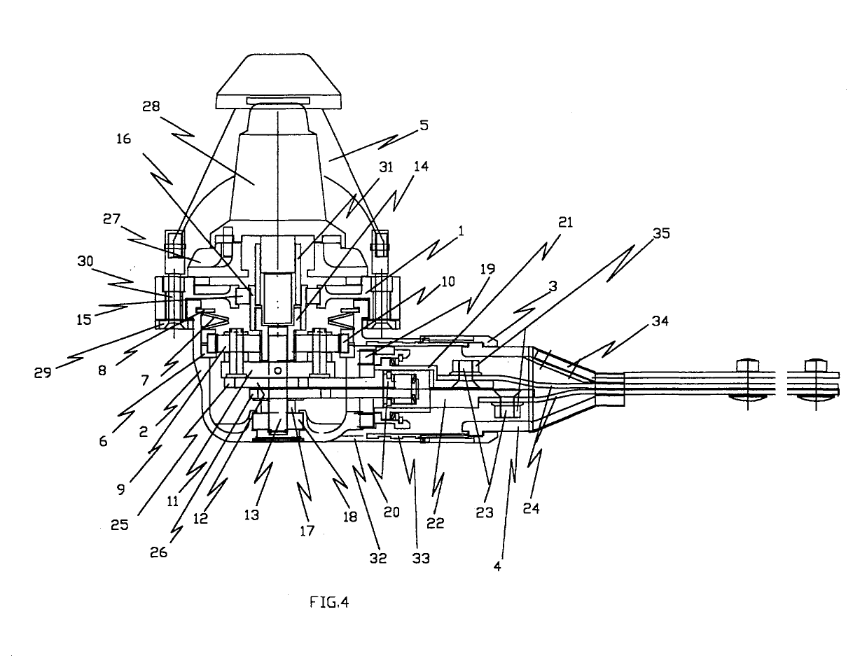

FIG. 4 shows a cross-section of the device, indicating:

1.—main body with co-printed bearing;

2.—gear box;

3.—oscillating blade rotation lock ring;

4.—blades and bars housing rotational support;

5.—bell or flange-shaped bracket for fixing bevel gear pair;

6.—limited slip clutch unit pre-loading ring, central unit and clutch rings;

7.—disk spring for pre-loading clutch unit;

8.—seger/lock ring;

9.—epicicloidal reduction gears;

10.—reduction gear collar;

11.—gear wheel support unit with transmission shaft secondary shaft coupling;

12.—opposing rockers;

13.—secondary transmission axis;

14.—primary transmission axis with gearing;

15.—bearing;

16.—gearing connected to transmission axis;

17.—spacer;

18.—co-printed bearing on gear box;

19.—oscillating unit with rotational joint upper and lower rods;

20.—oscillating unit with rotational joint lower rod;

21.—mobile unit with coupling to cutting bar and upper rod;

22.—mobile unit with coupling to cutting bar and lower rod;

23.—cutting bar fixing screws;

24.—cutting bars;

25.—upper rod;

26.—lower rod;

27.—adaptation washer to bevel gear pair;

28.—standard bevel gear pair for a trimming machine;

29.—support and alignment ring for oscillating unit gear box;

30.—bell/flange bracket fixing screws;

31.—ribbed joint for coupling mechanism and bevel gear pair;

32.—oscillating unit housing;

33.—printed insert on oscillating unit box;

34.—oscillating blades support rod;

35.—large-headed nuts to fix blades;

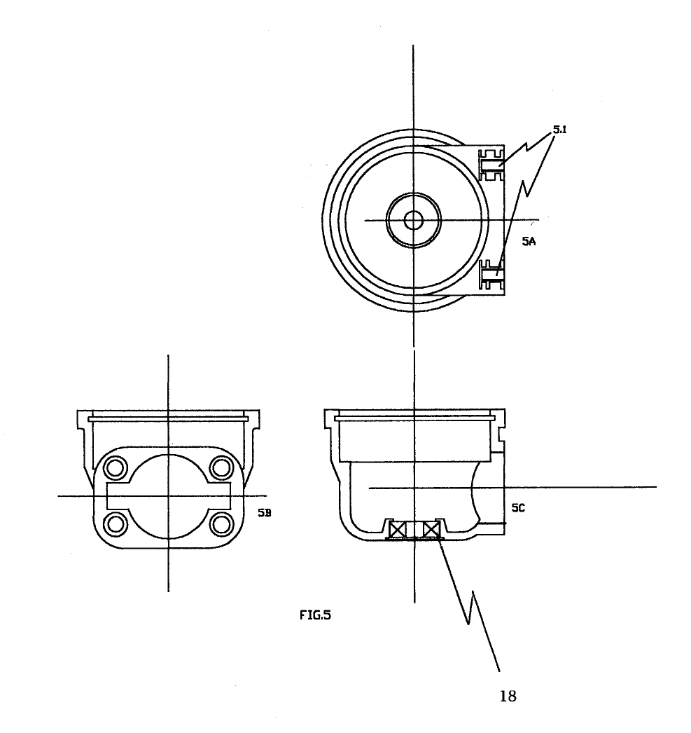

FIG. 5 shows the gear box, with:

5a—view from above in which 5.1 indicates the inserts;

5b—cross-section in which 5.1 indicates inserts;

5c—side view in which 18 indicates the co-printed bearing;

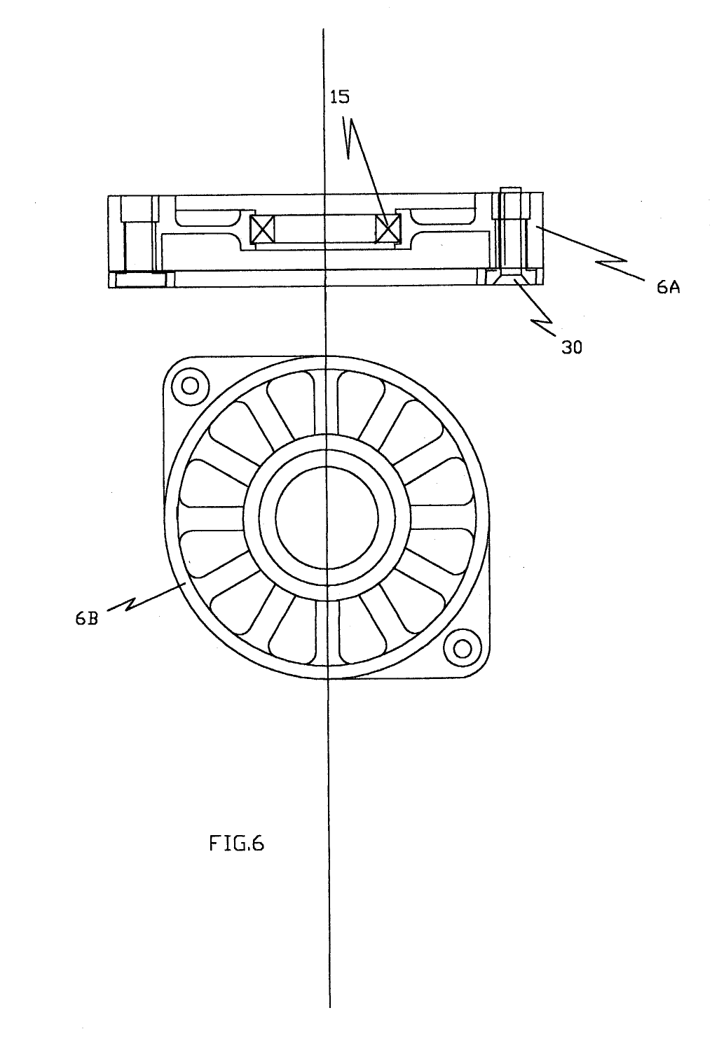

FIG. 6 shows the main body, with:

6a13 cross-section in which 15 is a bearing and 30 the lock screws;

6b—view from above;

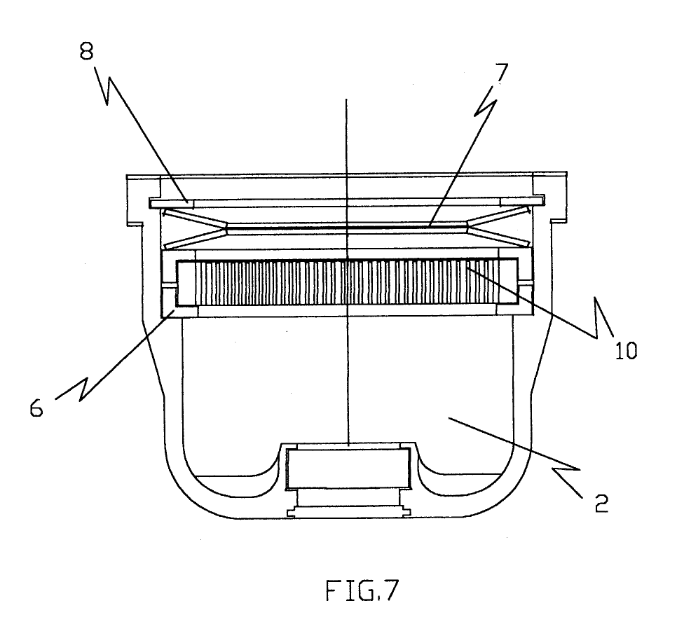

FIG. 7 shows the gear box 2, in which:

6.—lock ring;

7.—disk spring for pre-loading clutch unit

8.—seger ring;

10.—crown wheel;

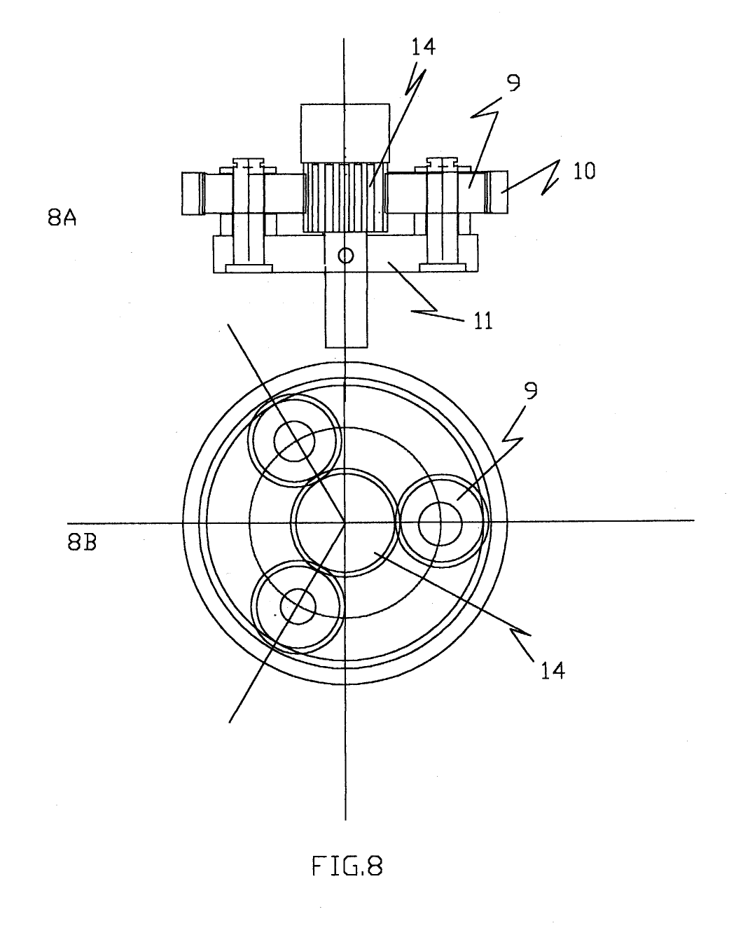

FIG. 8 shows the reduction unit, in which:

8a is the cross-section in which:

9.—three gear wheels;

10.—reduction ring;

11.—gear wheel housing unit;

14.—primary transmission axis with gears, in which: 8b is the view from above and 9 the gear wheels;

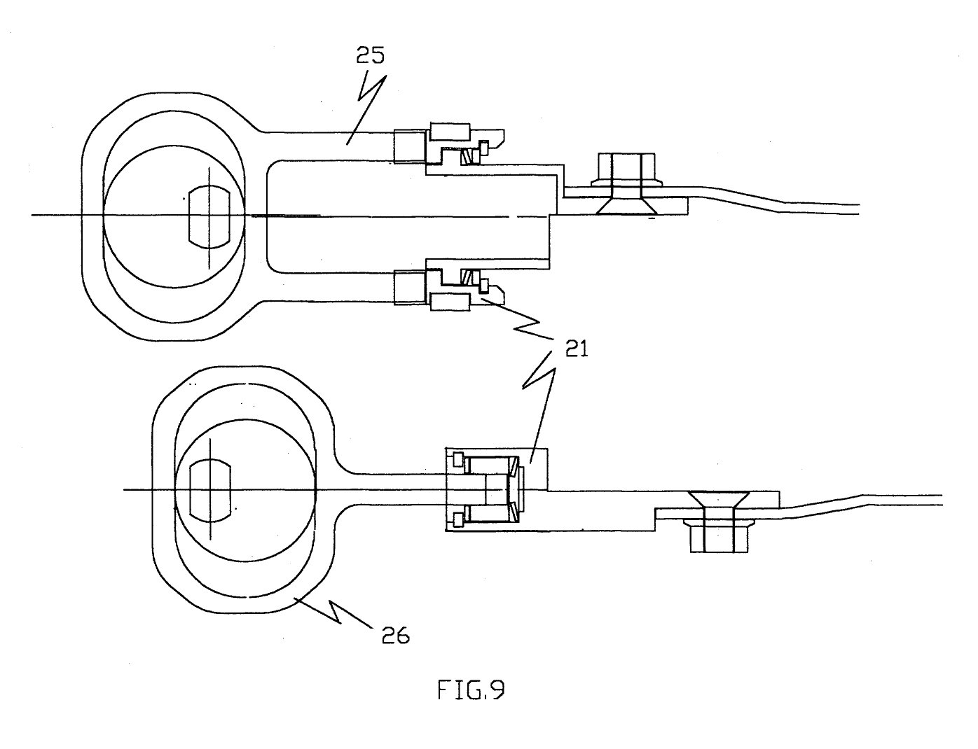

FIG. 9 shows:

21.—mobile device;

25.—upper oscillating rod; 26.—lower oscillating rod;

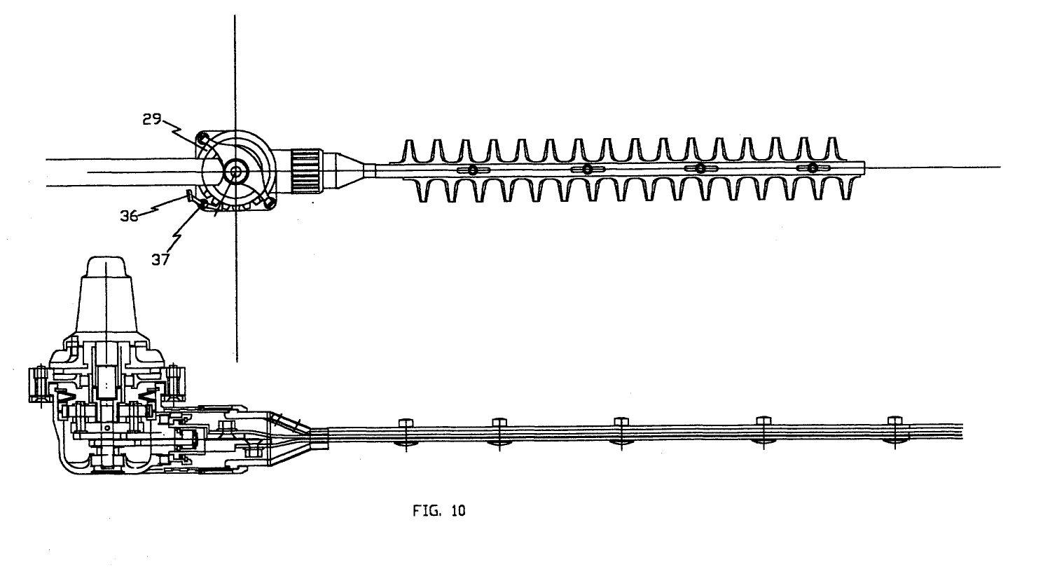

FIG. 10 shows:

29.—support and alignment ring for oscillating unit gear box; 36.—Rack ratchet lock 29, fitted with spring 37.

Operation of Mechanism

The mechanism is powered by any type of trimming machine. By means of a primary transmission axis 14, 16, 31, the mechanism enters the reduction unit 9, 10 where the reduction ratio is applied. Collar 10 is held on two rings 6 pre-loaded by spring 7 held by seger 8. This all enables a controlled sliding of collar 10. This is necessary so that when the blade of the mechanism encounters a hard obstacle (e.g. metal wire) the unit starts to slide so that the collar 10 runs on the runners 6, thereby avoiding any damage to the mechanism, which would have blocked blades on one side and an operational motor on the other. The operator avoids the obstacle and returns to work.

The secondary shaft 13, which takes its movement from reduction unit 1, transmits the movement to two rocking cams 12.

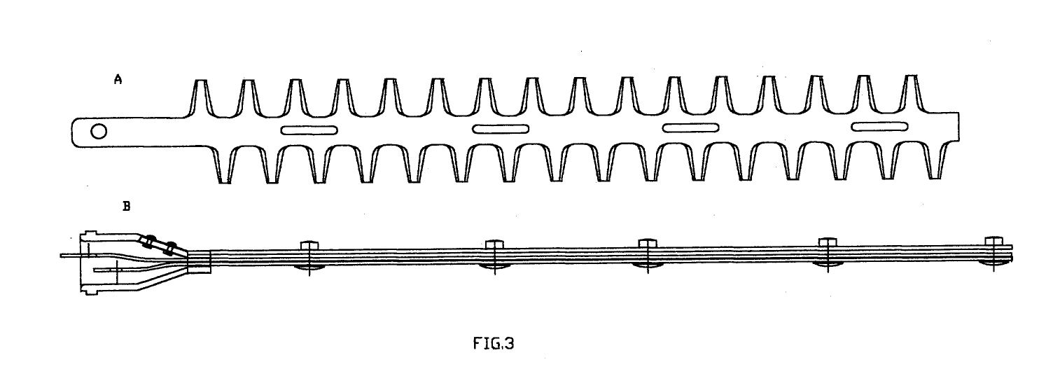

The rocking cams 12 are held in two rods 25 and 26 which reach the alternative movement in a coaxial rotational joint 21 and 20, where the rods 25 and 26 transfer the alternative movement regardless of the position of the rotating joint 21, 20. The blades 24 are fixed on the rotating joint 21, 20 by means of the screws 23. Since the blades are easily fixed they may be easily removed for maintenance purposes. In fact, the blade unit, as shown in FIG. 3, slides from the rotational unit which provides the transmission movement. All the parts with alternative movement are out of phase by 180° and balanced with each other in order to minimize the vibrations.

The movement on the horizontal plane, in order to adjust the mechanism at approximately 90° intervals is carried out by unlocking a ratchet fixed on collar 29 and releasing it in the desired position, usually by means of a pushbutton command.

The ratchet is composed of a lever on one side of which are the ratchets for locking support ring 29 and on the other side of which is a knob to unlock the clamp. The position is fixed by means of a spring 37 which holds the ratchet.

I claim:

1. Mechanical device characterized by: a main body (1) with a co-printed bearing, gear box (2), an oscillating blade; rotation lock ring (3), a rotational support of the blades and bar support (4), a bell or flange bracket to fix the bevel gear pair (5), a limited slip clutch unit pre-load ring, centering and friction rings (6), disk spring to pre-load clutch unit (7), lock ring/seger (8), epicycloidal reduction box gears (9), reduction collar (10), gear wheels support unit with transmission shaft secondary shaft coupling (11), opposing rockers (12), secondary transmission axis (13), primary transmission axis with gearing (14), a bearing (15), gearing connected to transmission axis (16), a spacer (17), a co-printed bearing on gear box (18), oscillating unit with rotational joint upper and lower rods (19), oscillating unit with rotational joint lower rod (20), mobile unit with coupling to cutting bar and upper rod (21), mobile unit with coupling to cutting bar and lower rod(22), cutting bar fixing screws (23), cutting bars (24), upper rod (25), lower rod (26), adaptation washer to bevel gear pair (27), standard bevel gear pair for a trimming machine (28), support and alignment ring for oscillating unit gear box (29), bell/flange bracket fixing screws (30), ribbed joint for coupling mechanism and bevel gear pair (31), oscillating unit housing (32), insert on oscillating unit box (33), oscillating blades support rod (34), large-headed nuts to fix blades (35).

2. Mechanical device, according to claim 1, characterized by the ability to operate on all orthogonal planes said device being constituted by its connection to toothed blades with alternative movements , adjusted to any angle, by means of a gear box (2) which provides the alternative movement; said gear box (2) being connected (6 the main body where, by means of a collar (29) and a ratchet (36, 37), the adjustments may be made in the plane passing through the transmission axis (31, 16, 14) of the bevel gear pair (28) forming part of the trimming machine.
